(19) United States
(12) Patent Application Publication
(10) Pub. No.: US 2002/0198894 A1
(43) Pub. Date: Dec. 26, 2002

(54) System, method and program for management of rebuilt parts of vehicles

(76) Inventor: Tomomitsu Tamura, Tokyo (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/138,514

(22) Filed: May 6, 2002

(30) Foreign Application Priority Data
Jun. 20, 2001 (JP) 2001-186520

(51) Int. Cl. G06F 7/00; G06F 17/00

(52) U.S. Cl. 707/104.1

(57) ABSTRACT

Establishment of traceability of rebuilt parts are required. A system for managing rebuilt parts of vehicles comprises a format delivering device, an information input device, an attached part database and an attached part database manager. A format delivering device delivers a vehicle communication format on which a part number and a part lot number of a rebuilt part are identified. An information input device is used to input to the system information on a vehicle to which the rebuilt part identified according to the vehicle communication format, is attached. An attached part database stores information on a vehicle to which the rebuilt part is attached, in such a way that the information is related to the part number and part lot number of the rebuilt part. An attached part database manager manages the attached part database. The attached part database manager retrieves from the attached part database, information on a vehicle to which a rebuilt part is attached, using the part number and part lot number of the rebuilt part as keys.

### BACKGROUND OF THE INVENTION

The present invention relates to a computer system, a method, a program and a communication sheet for establishing traceability of rebuilt parts of vehicles.

With increasing awareness of ecological problems, more and more parts of vehicles have been rebuilt. Parts to be rebuilt include, for example, distributors, power steering pumps, power steering gearboxes, drive shafts and torque converters.

These rebuilt parts received by part producers are subjected to processes of disassembling, cleaning, selection, part tolerance inspection, part function inspection, re-assembling and completed part inspection. Then, the parts are shipped to vehicle brand producers. Further, the parts received by vehicle brand producers are subjected to processes of assortment, storage, stock control and supply control before being shipped to part dealers or the like. The rebuilt parts shipped by part dealers or the like are received by typical service garages, part shops and vehicle dealers and finally attached to customers' vehicles.

On the other hand, vehicle producers keep and mainatain data of customers using a vehicle customer database in which sold vehicles and their customers are stored in such a way that both are related to each other, based on data of vehicle dealers. Accordingly, if a malfunction should be found in a group of parts and customers of the group of parts must be informed of the malfunction, the following procedure is carried out. First, a part number and a part lot number of the group of parts in which the malfunction has been found, are identified. Then, information of vehicles using the group of parts having the part number and part lot number, such as a vehicle type and a body number, is identified. Further, customers are identified through the vehicle customer database, using information of vehicles, such as a vehicle type and a body number, so that the customers are informed of the malfunction.

However, customers of rebuilt parts cannot be identified through the vehicle customer database based on data of vehicle dealers. The reasons are that some rebuilt parts have part lot numbers different from those of original parts and some rebuilt parts are attached to vehicles not contained in the vehicle customer database. Accordingly, when a malfunction is found in a type of rebuilt parts, vehicle brand producers hardly inform customers of the malfunction except in the case that vehicle dealers keep data of customers to whose vehicles they have attached the rebuilt parts.

Conventional computer systems dealing with data of vehicle parts are described in Japanese Patent Application Unexamined Publication No. 10-244912 and Japanese Patent Application Unexamined Publication No. 2001-71873, for example. The former discloses a system for management of repair of automobiles, storing information on repair of automobiles for better services of repair, while the latter discloses a system for management of automobiles by which customers can easily grasp a risk according to situation of maintenance of safety parts. Thus, these systems are not directed to management of customers of rebuilt parts.

Thus, conventionally there has not been a system or a method for managing customers of rebuilt parts in a unified way and therefore vehicle brand producers can hardly identify customers of a type of rebuilt parts found to malfunction, with few exceptions. In other words, typical service garages, vehicle dealers or the like that attach rebuilt parts are required to expend much time and trouble if they try to keep record of information on vehicles to which they have attached rebuilt parts. Further, it has not been easy for vehicle producers to collect information on rebuilt parts attached by the above shops with high reliability, while preventing error in entering data.

Accordingly, a computer system, a method, a program and a communication sheet for establishing traceability of rebuilt parts of vehicles and for managing customers of rebuilt parts in a unified way, are required.

### SUMMARY OF THE INVENTION

A system for managing rebuilt parts of vehicles, according to the present invention, comprises a format delivering device, an information input device, an attached part database and an attached part database manager. A format delivering device delivers a vehicle communication format on which a part number and a part lot number of a rebuilt part are identified. An information input device is used to input to the system information on a vehicle to which the rebuilt part identified according to the vehicle communication format, is attached. An attached part database stores pieces of information on vehicles to which rebuilt parts are attached, in such a way that the pieces of information are related to part numbers and part lot numbers of the rebuilt parts. An attached part database manager manages the attached part database. The attached part database manager retrieves from the attached part database, information on a vehicle to which the rebuilt part is attached, using the part number and part lot number of the rebuilt part as keys.

A method for managing rebuilt parts of vehicles, according to the present invention, is used in a system comprising an attached part database. The method is as follows. The system delivers a vehicle communication format on which a part number and a part lot number of a rebuilt part are identified. The system encourages information on a vehicle to which the rebuilt part identified according to the vehicle communication format, is attached, to be input to the system. The system stores pieces of information on vehicles to which rebuilt parts are attached, in the attached part database, in such a way that the pieces of information are related to part numbers and part lot numbers of the rebuilt parts. The system retrieves from the attached part database, information on a vehicle to which the rebuilt part is attached, using the part number and part lot number of the rebuilt part as keys.

A program for managing rebuilt parts of vehicles, according to the present invention, is used in a system comprising an attached part database. The program makes the system execute as follows. The system delivers a vehicle communication format on which a part number and a part lot number of a rebuilt part are identified. The system encourages information on a vehicle to which the rebuilt part identified according to the vehicle communication format, is attached, to be input to the system. The system stores pieces of information on vehicles to which rebuilt parts are attached, in the attached part database, in such a way that the pieces of information are related to part numbers and part lot numbers of the rebuilt parts. The system retrieves from the attached part database, information on a vehicle to which the rebuilt part is attached, using the part number and part lot number of the rebuilt part as keys.

According to the above construction of the present invention, a piece of information on a vehicle to which a rebuilt part has been attached, is input based on a vehicle communication format on which a part number and a part lot number of the rebuilt part are identified. Accordingly, an attached part database for storing pieces of information on vehicles to which rebuilt parts have been attached in such a way that the pieces of information are related to part numbers and part lot numbers, can be reliably created.

According to one aspect of a system of the present invention, the system further comprises a vehicle customer database and a database coordinator functioning in conjunction with the attached part database manager. The vehicle customer database stores customers to whom vehicles have been sold in such a way that the customers are related to the vehicles. The database coordinator compares a piece of information on a vehicle in a predetermined record of the attached part database with a piece of information on a vehicle in each record of the vehicle customer database. When both pieces of information are found to be identical with each other, the database coordinator adds indicating information to the record of the vehicle customer database.

According to one aspect of a method and a program of the present invention, the system further comprises a vehicle customer database storing customers to whom vehicles have been sold in such a way that the customers are related to the vehicles. The system compares a piece of information on a vehicle in a predetermined record of the attached part database with a piece of information on a vehicle in each record of the vehicle customer database. When both pieces of information are found to be identical with each other, the system adds indicating information to the record of the vehicle customer database.

According to the above construction of the above aspect of the present invention, indicating information is added in the attached part database to a record of a vehicle to which a rebuilt part has been attached. Accordingly, latest information can be kept.

According to another aspect of the present invention, the attached part database further stores pieces of information on customers in such a way that the pieces of information are related to part numbers and part lot numbers of rebuilt numbers.

Further, according to another aspect of a system of the present invention, the database coordinator compares a piece of information on a customer in a predetermined record of the attached part database with a piece of information on a customer in each record of the vehicle customer database. When both pieces of information are found to be identical with each other, the database coordinator adds indicating information to the record of the vehicle customer database.

Further, according to another aspect of a method and a program of the present invention, the system compares a piece of information on a customer in a predetermined record of the attached part database with a piece of information on a customer in each record of a vehicle customer database storing customers to whom vehicles have been sold in such a way that the customers are related to the vehicles. When both pieces of information are found to be identical with each other, the system adds indicating information to the record of the vehicle customer database.

According to the above construction of the above aspect of the present invention, indicating information is added in the attached part database to a record of a customer of a vehicle to which a rebuilt part has been attached. Accordingly, latest information can be kept.

Further, according to another aspect of a system of the present invention, the system further comprises a vehicle customer database manager for managing the vehicle customer database. The vehicle customer database manager retrieves pieces of information on customers, using pieces of information on vehicles and classifies the retrieved pieces of information, based on the indicating information added by the database coordinator.

Further, according to another aspect of a method and a program of the present invention, the system retrieves pieces of information on customers, using pieces of information on vehicles and classifies the retrieved information, based on the indicating information added.

According to the above construction of the above aspect of the present invention, pieces of information on customers can be classified and kept based on the information on attachment of rebuilt.

A vehicle communication sheet according to the present invention, comprises a single leaf. The single leaf is provided thereon with a first information recording field for recording information on a vehicle to which a rebuilt part is attached, a second information recording field for recording information on a customer of the vehicle and another field in which information of the rebuilt part has been previously recorded.

According to the above construction, information on a vehicle to which a rebuilt part is attached and information on a customer of the vehicle can be reliably grasped based on information of the rebuilt part previously recorded on the communication sheet.

According to one aspect of a communication sheet of the present invention, the communication sheet further comprising a third information recording field for recording information on a shop in which the rebuilt part has been attached.

According to the construction of the above aspect, information on a shop in which the rebuilt part has been attached, can be grasped. The information can be conveniently used for communication with customers.

According to another aspect of a communication sheet of the present invention, the communication sheet comprises a multipart form, one part for being returned to a vehicle brand producer and the other part for use by a customer.

According to the construction of the above aspect, customers can keep records of the attached rebuilt parts. If a malfunction is found, they can communicate with the shops in which the rebuilt parts have been attached and the vehicle brand producer, based on the records, to obtain prompt services.

According to another aspect of a communication sheet of the present invention, the communication sheet has a code for identifying the rebuilt part previously recorded thereon.

The construction of the above aspect allows the code to be read by a scanner or the like to identify a rebuilt part reliably and correctly when information on the rebuilt part is input into the system.

According to the above constructions, the vehicle brand producer can obtain the latest information on rebuilt parts, while utilizing the existing vehicle customer database. In other words, vehicles to which rebuilt parts have been attached and customers of the vehicles can be grasped. Further, whether vehicles and customers registered in the vehicle customer database, utilize rebuilt parts or not, can be grasped.

According to the present invention, a piece of information on a vehicle to which a rebuilt part has been attached, is input based on a vehicle communication format on which a part number and a part lot number of the rebuilt part are identified. Accordingly, an attached part database for storing pieces of information on vehicles to which rebuilt parts have been attached in such a way that the pieces of information are related to part numbers and part lot numbers, can be reliably created. Thus, vehicles to which rebuilt parts have been attached and customers of the vehicles can be reliably grasped.

Use of a format such as a vehicle communication sheet, lightens the load for shops in grasping data and allows the vehicle brand producer to reliably and correctly collect pieces of information on rebuilt parts.

Further, information is added in the existing vehicle customer database to a record for a vehicle to which a rebuilt part has been attached and therefore the latest information can be kept while using the existing vehicle customer database. Further, whether vehicles and customers registered in the vehicle customer database, utilize rebuilt parts or not, can be grasped.

Thus, the vehicle brand producer can trace rebuilt parts of vehicles and can establish higher quality assurance system.

### BRIEF DESCRIPTION OF THE DRAWINGS

FIG. 1 is a general view of a configuration of a system according to the present invention;

FIG. 2 is a concrete example of a construction of an attached part database;

FIG. 3 is a concrete example of a vehicle communication format;

FIG. 4 is a concrete example of a construction of vehicle customer database;

FIG. 5 is a flowchart of the procedure of generating the attached part database;

FIG. 6 is a flowchart of the procedure of retrieving a recorded data from the attached part database;

FIG. 7 is a flowchart of function of the database coordinator; and

FIG. 8 is a flowchart of the procedure of retrieving data from the vehicle customer database.

### DESCRIPTION OF PREFERRED EMBODIMENTS

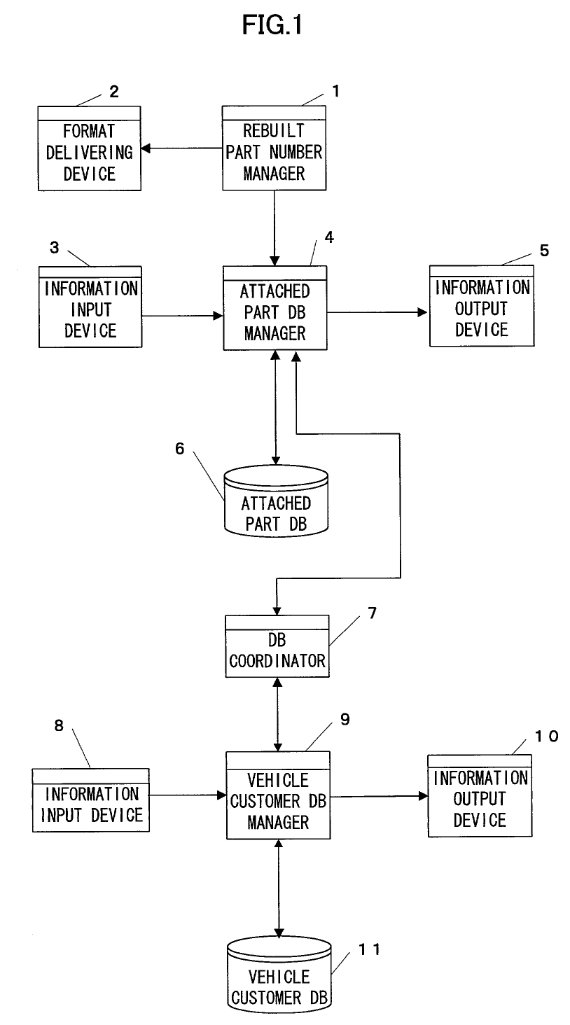

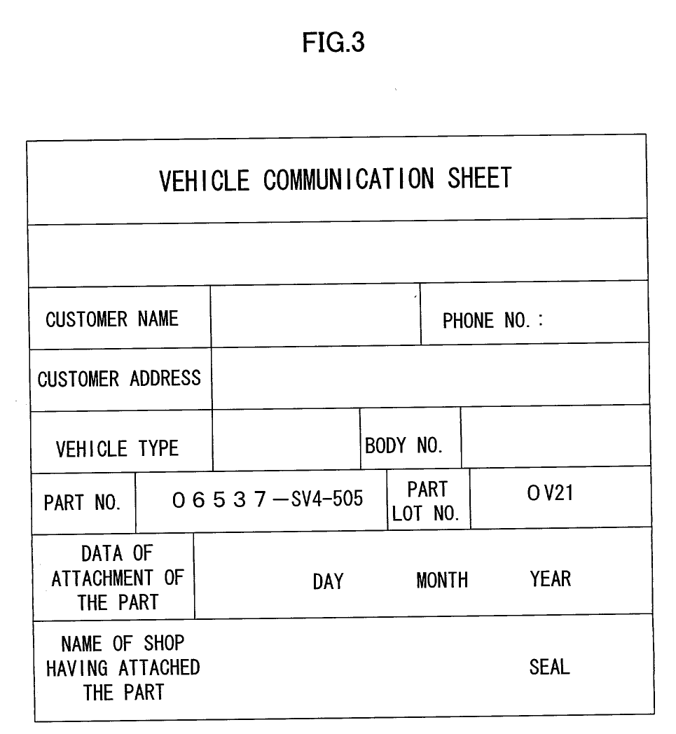

FIG. 1 shows an outline of a system according to the present invention. The system includes a rebuilt part number manager 1 for managing part numbers and part lot numbers of rebuilt parts. Part numbers and part lot numbers may be entered into the system through an input device not shown. The rebuilt part number manager 1 sends information including a part number and a part lot number to a communication format delivering device 2. The communication format delivering device 2 delivers a vehicle communication format on which a part number and a part lot number of a rebuilt part are identified. An example of the communication format is shown in FIG. 3. On the format, the part number and part lot number of the rebuilt part are already provided for identification. Further, fields are provided for recording a vehicle type, a body number, a customer name, a customer address, a customer phone number, a date of attachment of the part, a shop that has attached the part or the like. Such a format may be printed on a medium such as a paper sheet, as a communication sheet and shipped with a rebuilt part to a typical service garage via a part dealer. Alternatively, such a format may be displayed at a terminal of the system as a screen format.

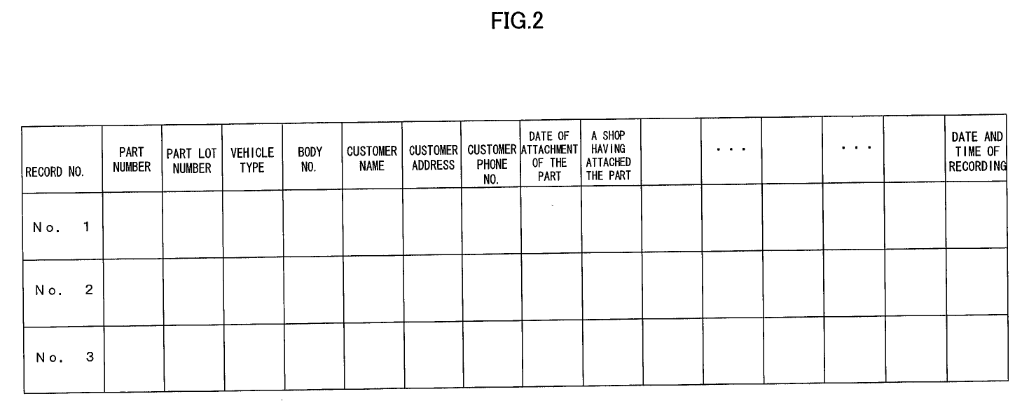

The system also includes an attached part database 6 for storing information of a vehicle to which the rebuilt part has been attached in such a way that the information of the vehicle is related with a part number and a part lot number of the rebuilt part. A concrete example of a construction of the attached part database 6 is shown in FIG. 2. A record is provided for each part. Each record includes pieces of information, such as a part number, a part lot number, a vehicle type, a body number, a customer name, a customer address, a customer phone number, a date of attachment of the part, a shop that has attached the part and date and time of recording. The attached part database 6 is arranged for search using any of the above pieces of information, as a key.

The system also includes an attached part database manager 4 for managing the attached part database 6. The attached part database manager 4 for managing the attached part database is arranged to share part numbers and part lot numbers of rebuilt parts with the rebuilt part number manager 1. Alternatively, the attached part database manager 4 for managing the attached part database may be arranged to contain the function of the rebuilt part number manager 1.

Generally, a database and a database manager can be realized by modifying, if necessary, and installing a commercially available database and a searching engine into a personal computer. Further, information input and output devices and a database coordinator to be described below, can be realized also by personal computer and their peripherals. Databases, database managers, information input and output devices and a database coordinator may be realized by a single personal computer. Alternatively, they may be realized by a number of personal computers arranged to communicate one another via an intranet. Further, when information input and output devices are placed at remote sites, the Internet as well as commercially available security protecting function, if necessary, may be used to connect them.

The system includes an information input device 3 for inputting data into the attached part database 6. Information is input according to the above mentioned vehicle communication format.

More specifically, suppose that the communication format is delivered as a communication sheet on a medium such as a paper sheet and a rebuilt part with the communication sheet is shipped via a part dealer to a service garage, a vehicle dealer or the like. In this case, pieces of information on a vehicle to which the rebuilt part is attached and its customer are recorded on the communication sheet at the service garage, the vehicle dealer or the like when the vehicle and the customer are identified. Then, the communication sheet is returned to the vehicle brand producer in a retrograde order of the shipment of the part. A facsimile device or the like may be used to return contents of the communication sheet. The communication sheet may be a multiple form and one form is to be returned to the vehicle brand producer, while the other form is to be passed to the customer for his or her use. At the vehicle brand producer, pieces of information on the filled and returned communication sheet are input through an information input device 3 into the attached part database. The format delivering device 2 of the system may previously print on the communication sheet a bar code or a two-dimensional code indicating the part number and part lot number so that the code can be read by a scanner for inputting information. As a result, the system can correctly and reliably identify the part number and part lot number.

Alternatively, suppose that the communication format is displayed as a screen format at a terminal of the system. In this case, pieces of information on a vehicle to which the rebuilt part is attached and its customer are input through the terminal (an information input device 3) at the service garage, the vehicle dealer or the like when the vehicle and the customer are identified. The format delivering device 2 of the system may previously print on a label for a package of the rebuilt part a bar code or a two-dimensional code indicating the part number and part lot number so that the code can be read by a scanner for inputting information. As a result, the system can identify the part number and part lot number and display the corresponding screen format. Further, a copy of the screen format filled with data may be printed and passed to the customer for his or her use.

The system also includes an information output device 5 for outputting information from the attached part database.

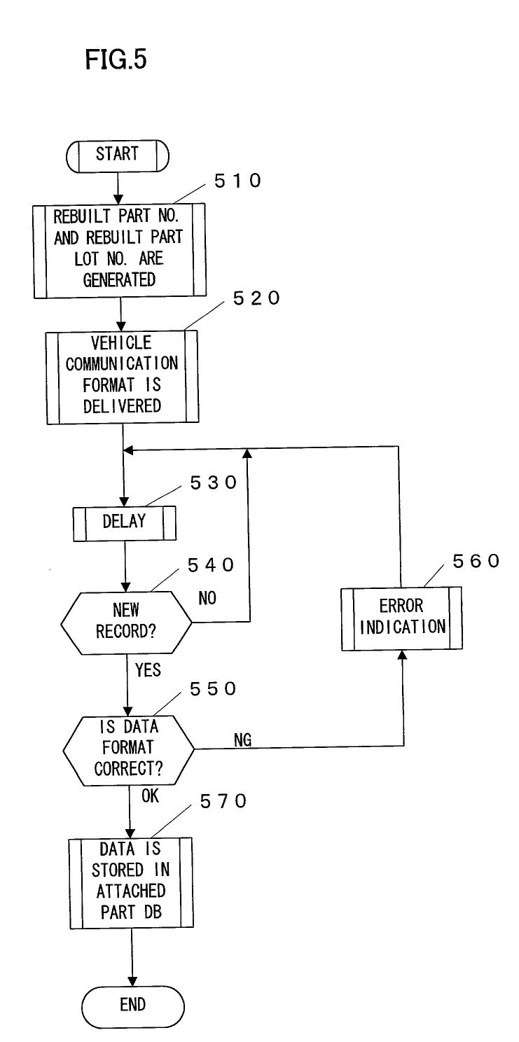

The procedure of generating the attached part database 6 will be described below according to the flowchart of FIG. 5. The rebuilt part number manager 1 generates a rebuilt part number and a rebuilt part lot number (step 510). The rebuilt part number manager 1 passes the rebuilt part number and rebuilt part lot number to the communication format delivering device 2, which delivers a vehicle communication format (step 520). The rebuilt part number manager 1 passes the rebuilt part number and rebuilt part lot number to the attached part database manager 4 for managing the attached part database. The attached part database manager 4 for managing the attached part database waits until information on the rebuilt part number and rebuilt part lot number is input through the information input device 3 (steps 530 and 540). When the information is input, the information input device 3 checks whether a format of the input data is correct or not (step 550). If the format is not correct, an error indication is displayed to ask for another input with a correct data format (560). If the format is correct, the information input device 3 sends the input data to the attached part database manager 4 for managing the attached part database, which then has the attached part database 6 store the input data in such a way that the information is related with the part number and part lot number of the rebuilt part (step 570).

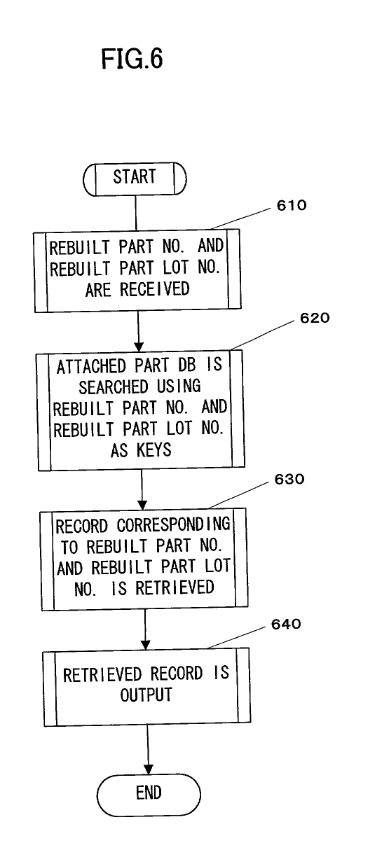

Further, the procedure of retrieving a recorded data from the attached part database 6, will be described according to the flowchart of FIG. 6. An information input device 3 receives a rebuilt part number and a rebuilt part lot number (step 610). The information input device may be the one through which the data on the vehicle communication format is input, or may be another one. Suppose that the same information input device 3 with the one through which the data on the vehicle communication format is input, is used in the description below. The information input device 3 passes the rebuilt part number and rebuilt part lot number to the attached part database manager 4 for managing the attached part database. The attached part database manager 4 for managing the attached part database searches the attached part database 6, using the rebuilt part number and rebuilt part lot number as keys (step 620) to retrieve a record corresponding to the rebuilt part number and rebuilt part lot number (step 630). Then, the attached part database manager 4 for managing the attached part database passes the retrieved record to the information output device 5 for output (step 640).

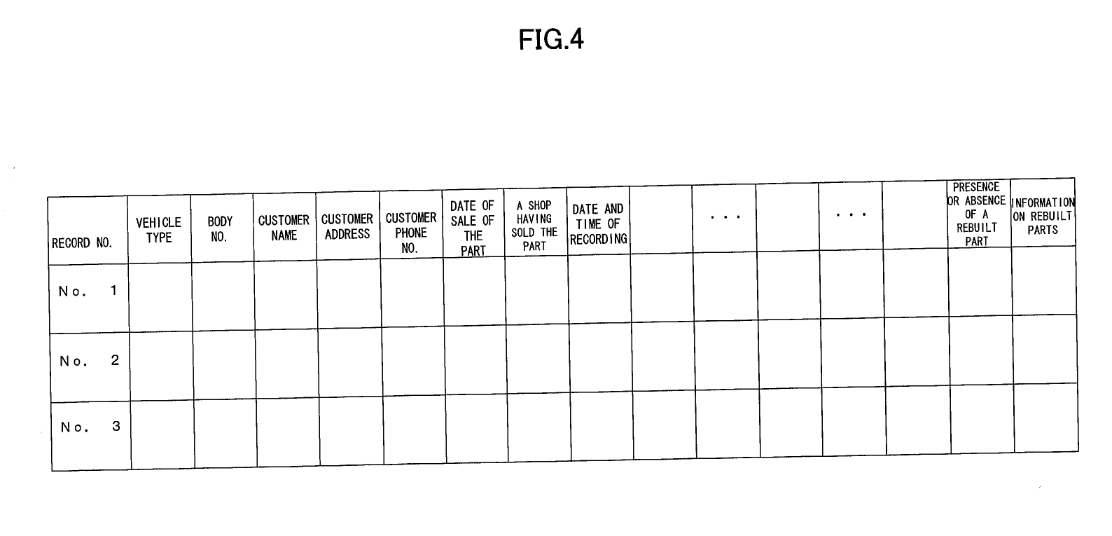

The system also includes a vehicle customer database 11 shown in FIG. 1. The vehicle customer database 11 is generated based on data obtained by vehicle dealers at points of sales. A concrete example of a construction of the vehicle customer database 11 is shown in FIG. 4. A record is provided for each vehicle. Each record includes pieces of information, such as a vehicle type, a body number, a customer name, a customer address, a customer phone number, a date of sales, a dealer and date and time of recording. The vehicle customer database 11 is arranged for search using any of the above pieces of information, as a key.

The system also includes a vehicle customer database manager 9 for managing data of the vehicle customer database 11. The system also includes an information input device 8 and an information output device 10, through which the vehicle customer database manager 9 for managing data of the vehicle customer database 11 inputs and outputs data to and from the vehicle customer database 11, respectively.

The system may include a database coordinator 7 for coordination between the attached part database 6 and the vehicle customer database 11. The database coordinator 7 functions in connection with the attached part database manager 4 for managing the attached part database and the vehicle customer database manager 9 for managing data of the vehicle customer database.

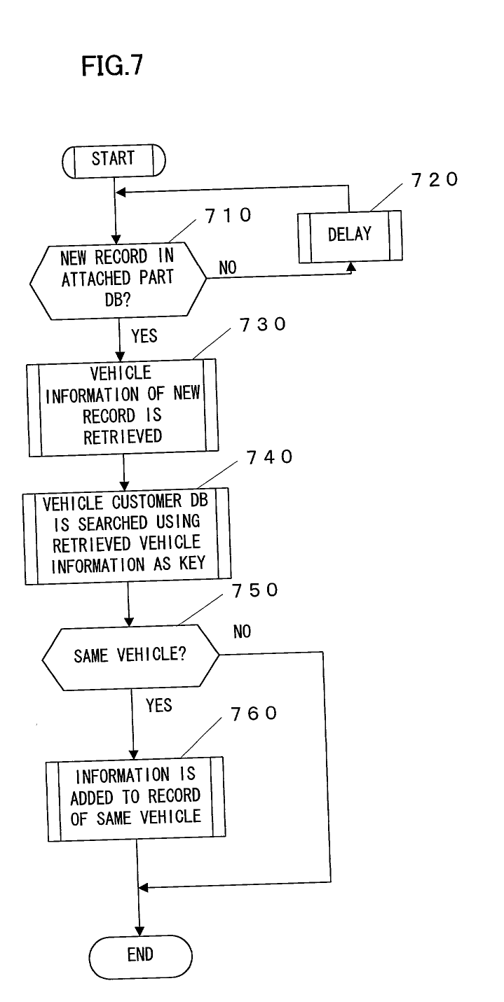

Function of the database coordinator 7 will be described below according to the flowchart of FIG. 7. The database coordinator 7 checks whether or not a new record is recorded in the attached part database 6, using the attached part database manager 4 for managing the attached part database (step 710). The attached part database manager 4 for managing the attached part database may examine the field of date and time of recording in a record in the attached part database 6, for the check. The database coordinator 7 performs the check at predetermined intervals unless a new record is recorded (step 720). If a new record is recorded, the database coordinator 7 retrieves information of the new record, such as a vehicle type and a body number via the attached part database manager 4 for managing the attached part database (step 730). Then, the database coordinator 7 instructs the vehicle customer database manager 9 for managing data of the vehicle customer database to search the vehicle customer database 9 using the retrieved information of the vehicle, such as the vehicle type and the body number, as keys. Then, the vehicle customer database manager 9 for managing data of the vehicle customer database searches the vehicle customer database 11 (step 740). When a record with the same vehicle type and body number as those of the new record, is found (step 750), the vehicle customer database manager 9 for managing data of the vehicle customer database informs the database coordinator 7 of the result. The database coordinator 7 then instructs the vehicle customer database manager 9 for managing data of the vehicle customer database to add predetermined indicating information in the record with the same vehicle type and body number as those of the new record. The vehicle customer database manager 9 for managing data of the vehicle customer database, adds the predetermined information in the record (step 760). The predetermined indicating information may include a flag indicating attachment of the rebuilt part. It may further include a part number and a part lot number of a rebuilt part. Thus, information on rebuilt parts is added to the vehicle customer database 11, based on information on a vehicle.

In step 730 and the succeeding steps, operations are performed based on information on a vehicle, such as a vehicle type and a body number. Alternatively, operations may be performed based on information on a customer, such as a customer name and a customer phone number instead of or in addition to the information on a vehicle. Thus, information on a rebuilt part is added to the vehicle customer database 11, using information on a customer.

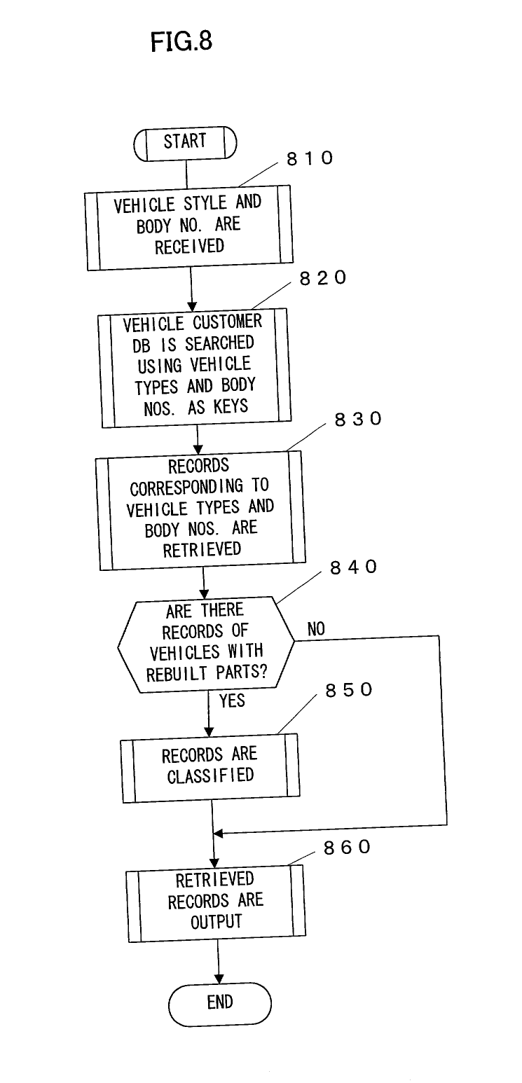

Now, the procedure of retrieving data from the vehicle customer database 11, will be described according to the flowchart of FIG. 8. The information input device 8 receives sets of a vehicle type and a body number (step 810). The information input device 8 passes the sets to the vehicle customer database manager 9 for managing data of the vehicle customer database. The vehicle customer database manager 9 for managing data of the vehicle customer database searches the vehicle customer database 11 using the sets as keys (step 820) and retrieves the records corresponding to the sets (step 830). Then, the vehicle customer database manager 9 for managing data of the vehicle customer database checks whether or not among the retrieved records there exist those for vehicles to which rebuilt parts have been attached (step 840). More specifically, the vehicle customer database manager 9 for managing data of the vehicle customer database may examine a field in a record, for a flag indicating attachment of a rebuilt part. If among the retrieved records there exist those for vehicles to which rebuilt parts have been attached, the vehicle customer database manager 9 for managing data of the vehicle customer database sorts the retrieved records depending on presence or absence of a rebuilt part (step 850). Further, the vehicle customer database manager 9 for managing data of the vehicle customer database may be arranged to sort the retrieved records depending on part numbers and part lot numbers of rebuilt parts. Then, the vehicle customer database manager 9 for managing data of the vehicle customer database passes the retrieved records to the information output device 10 for output (step 860). Thus, data in the vehicle customer database 11 may be sorted depending on information of rebuilt parts before being output.

What is claimed is:

1. A system for managing rebuilt parts of vehicles, comprising:
a format delivering device for delivering a vehicle communication format on which a part number and a part lot number of a rebuilt part are identified;
an information input device through which information on a vehicle to which the rebuilt part identified according to the vehicle communication format, is attached, is input to the system;
an attached part database for storing pieces of information on vehicles to which rebuilt parts are attached, in such a way that the pieces of information are related to part numbers and part lot numbers of the rebuilt parts; and
an attached part database manager for managing the attached part database, wherein the attached part database manager retrieves from the attached part database, information on a vehicle to which the rebuilt part is attached, using the part number and part lot number of the rebuilt part as keys.

2. A system for managing rebuilt parts of vehicles according to claim 1, further comprising a vehicle customer database storing customers to whom vehicles have been sold in such a way that the customers are related to the vehicles and a database coordinator functioning in conjunction with the attached part database manager, wherein the database coordinator compares a piece of information on a vehicle in a predetermined record of the attached part database with a piece of information on a vehicle in each record of the vehicle customer database and when both pieces of information are found to be identical with each other, the database coordinator adds indicating information to the record of the vehicle customer database.

3. A system for managing rebuilt parts of vehicles according to claim 1, wherein the attached part database further stores pieces of information on customers in such a way that the pieces of information are related to part numbers and part lot numbers of the rebuilt parts.

4. A system for managing rebuilt parts of vehicles according to claim 3, further comprising a vehicle customer database storing customers to whom vehicles have been sold in such a way that the customers are related to the vehicles and a database coordinator functioning in conjunction with the attached part database manager, wherein the database coordinator compares a piece of information on a customer in a predetermined record of the attached part database with a piece of information on a customer in each record of the vehicle customer database and when both pieces of information are found to be identical with each other, the database coordinator adds indicating information to the record of the vehicle customer database.

5. A system for managing rebuilt parts of vehicles according to claim 2 or 4, further comprising a vehicle customer database manager for managing the vehicle customer database, wherein the vehicle customer database manager retrieves pieces of information on customers, using pieces of information on vehicles and classifies the retrieved pieces of information, based on the indicating information added by the database coordinator.

6. A method for managing rebuilt parts of vehicles used in a system comprising an attached part database, the method comprising the following:
the system delivering a vehicle communication format on which a part number and a part lot number of a rebuilt part are identified;
the system encouraging information on a vehicle to which the rebuilt part identified according to the vehicle communication format, is attached, to be input to the system;
the system storing pieces of information on vehicles to which rebuilt parts are attached, in the attached part database, in such a way that the pieces of information are related to part numbers and part lot numbers of the rebuilt parts; and
the system retrieving from the attached part database, information on a vehicle to which the rebuilt part is attached, using the part number and part lot number of the rebuilt part as keys.

7. A method for managing rebuilt parts of vehicles according to claim 6, wherein the system further comprises a vehicle customer database storing customers to whom vehicles have been sold in such a way that the customers are related to the vehicles and the system compares a piece of information on a vehicle in a predetermined record of the attached part database with a piece of information on a vehicle in each record of the vehicle customer database and when both pieces of information are found to be identical with each other, the system adds indicating information to the record of the vehicle customer database.

8. A method for managing rebuilt parts of vehicles according to claim 6, wherein the attached part database further stores pieces of information on customers in such a way that the pieces of information are related to part numbers and part lot numbers of rebuilt numbers.

9. A method for managing rebuilt parts of vehicles according to claim 8, wherein the system further comprises a vehicle customer database storing customers to whom vehicles have been sold in such a way that the customers are related to the vehicles and the system compares a piece of information on a customer in a predetermined record of the attached part database with a piece of information on a customer in each record of a vehicle customer database storing customers to whom vehicles have been sold in such a way that the customers are related to the vehicles and when both pieces of information are found to be identical with each other, the system adds indicating information to the record of the vehicle customer database.

10. A method for managing rebuilt parts of vehicles according to claim 7 or 9, wherein the system retrieves pieces of information on customers, using pieces of information on vehicles and classifies the retrieved information, based on the indicating information added by the database coordinator.

11. A program for managing rebuilt parts of vehicles, used in a system comprising an attached part database, wherein the program makes the system execute the following:
the system delivering a vehicle communication format identifying a part number and a part lot number of a rebuilt part;
the system encouraging information on a vehicle to which the rebuilt part identified according to the vehicle communication format, is attached, to be input to the system;
the system storing pieces of information on vehicles to which rebuilt parts are attached, in the attached part database, in such a way that the pieces of information are related to part numbers and part lot numbers of the rebuilt parts; and
the system retrieving from the attached part database, information on a vehicle to which the rebuilt part is attached, using the part number and part lot number of the rebuilt part as keys.

12. A program for managing rebuilt parts of vehicles according to claim 11, wherein the system further comprises a vehicle customer database storing customers to whom vehicles have been sold in such a way that the customers are related to the vehicles and the system is made to compare a piece of information on a vehicle in a predetermined record of the attached part database with a piece of information on a vehicle in each record of the vehicle customer database and to add indicating information to the record of the vehicle customer database when both pieces of information are found to be identical with each other.

13. A program for managing rebuilt parts of vehicles according to claim 11 or 12, wherein the attached part database is made to further store pieces of information on customers in such a way that the pieces of information are related to part numbers and part lot numbers of rebuilt numbers.

14. A program for managing rebuilt parts of vehicles according to claim 13, wherein the system further comprises a vehicle customer database storing customers to whom vehicles have been sold in such a way that the customers are related to the vehicles and the system is made to compare a piece of information on a customer in a predetermined record of the attached part database with a piece of information on a customer in each record of a vehicle customer database storing customers to whom vehicles have been sold in such a way that the customers are related to the vehicles and when both pieces of information are found to be identical with each other, the system is made to add indicating information to the record of the vehicle customer database.

15. A program for managing rebuilt parts of vehicles according to claim 12 or 14, wherein the system is made to retrieve pieces of information on customers, using pieces of information on vehicles and to classify the retrieved information, based on the indicating information added.

16. A vehicle communication sheet comprising a single leaf provided thereon with a first information recording field for recording information on a vehicle to which a rebuilt part is attached, a second information recording field for recording information on a customer of the vehicle and another field in which information of the rebuilt part has been previously recorded.

17. A vehicle communication sheet according to claim 16, further comprising a third information recording field for recording information on a shop in which the rebuilt part has been attached.

18. A vehicle communication sheet according to claim 16, comprising a multipart form, one part for being returned to a vehicle brand producer and the other part for use by a customer. 19. A vehicle communication sheet according to any one of claims 16 to 18, having a code for identifying the rebuilt part previously recorded thereon.
